(19) United States
(12) Patent Application Publication
(10) Pub. No.: US 2009/0176514 A1
(43) Pub. Date: Jul. 9, 2009

(54) RADIO COMMUNICATION DEVICE AND METHOD FOR CONTROLLING A RADIO COMMUNICATION DEVICE

(75) Inventors: HYUNG-NAM CHOI, Hamburg (DE); Manfred Zimmermann, Sauerlach (DE); Christian Drewes, Germering (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/971,560

(22) Filed: Jan. 9, 2008

(51) Int. Cl. H04Q 7/20

(52) U.S. Cl. 455/458

(57) ABSTRACT

In an embodiment, a radio communication device is provided. A radio communication device may include a paging channel capacity setting circuit configured to set a paging channel capacity individually for another radio communication device.

### TECHNICAL FIELD

Embodiments relate generally to radio communication devices and methods for controlling thereof.

### BACKGROUND

Paging mechanisms are specified in various cellular mobile radio communication systems. A paging mechanism allows the mobile radio communication network to transmit messages to a user mobile radio communication terminal device, which is in an idle or sleep mode, in an energy efficient manner (from the point of view of the user mobile radio communication terminal device). In idle or sleep mode, there is no active connection for data transmission between the user mobile radio communication terminal device and the mobile radio communication network. However, the user mobile radio communication terminal device is configured to receive paging signals, e.g. to receive a notification about an incoming call.

By way of example, paging may be carried out in Universal Mobile Telecommunications System (UMTS) based on Code Division Multiple Access (CDMA) as follows:

The user mobile radio communication terminal device monitors in regular time distances the Paging Indicator CHannel (PICH), which is assigned to the user mobile radio communication terminal device by the network, and via which a defined number of paging identifiers (bit patterns) is transmitted.

In case a paging identifier assigned to the mobile radio communication terminal device by the network is detected on this PICH, the mobile radio communication terminal device then detects a Secondary Common Control Physical Channel (S-CCPCH) associated with the PICH in a fixed time distance τ_{PICH} (in an example, τ_{PICH}=7680 chips=2 ms), via which a paging message has been transmitted.

Usually, an assignment of a paging identifier to a mobile radio communication terminal device is not unambiguous, since a high number of mobile radio communication terminal devices may be present in a mobile radio cell, and since the available number of paging identifiers is limited.

Therefore, it may happen that the mobile radio communication terminal device reads the paging message on the S-CCPCH, although the paging message was meant to belong to another mobile radio communication terminal device.

Currently, one issue in the Third Generation Partnership Project (3GPP) standardization groups is the further development of UMTS to a mobile radio communication system optimized for packet data transmission by improving e.g. the system capacity and the spectral efficiency. This further development is made under the name “Long Term Evolution” (LTE). The target is, inter alia, to significantly increase the maximum net transmission rates in the future, up to 100 Mbps in downlink transmission direction and up to 50 Mbps in uplink transmission direction.

For the LTE mobile radio communication system, various multiple access methods are specified. For example, a combined Orthogonal Frequency Division Multiple Access/Time Division Multiple Access (OFDMA/TDMA) transmission method is provided in the downlink transmission direction and a combined Single Carrier Frequency Division Multiple Access/Time Division Multiple Access (SC-FDMA/TDMA) transmission method is provided in the uplink transmission direction.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the embodiments. In the following description, various embodiments are described with reference to the following drawings, in which:

FIG. 1 shows a mobile radio communication system in accordance with an embodiment;

FIG. 2 shows a paging indication scheme in a paging time diagram;

FIGS. 3A to 3C show various diagrams illustrating time division multiple access (FIG. 3A), frequency division multiple access (FIG. 3B), and code division multiple access (FIG. 3C);

FIG. 4 shows a mobile radio communication network device in accordance with an embodiment;

FIG. 5 shows a method for controlling a mobile radio communication network device in accordance with an embodiment;

FIG. 6 shows a mobile radio communication terminal device in accordance with an embodiment;

FIG. 7 shows a method for controlling a mobile radio communication terminal device in accordance with an embodiment;

FIG. 8 shows an implementation of an orthogonal frequency division multiplex modulator and of an orthogonal frequency division multiplex demodulator using inverse fast fourier transformation and fast fourier transformation, respectively;

FIG. 9 shows a paging indication scheme in a paging time diagram in accordance with an embodiment; and

FIG. 10 shows a paging indication scheme in a paging time diagram in accordance with another embodiment.

### DESCRIPTION

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). As will be described in more detail below, a “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the description, the terms “connection” and “coupling” are intended to include a direct as well as an indirect “connection” and “coupling”, respectively.

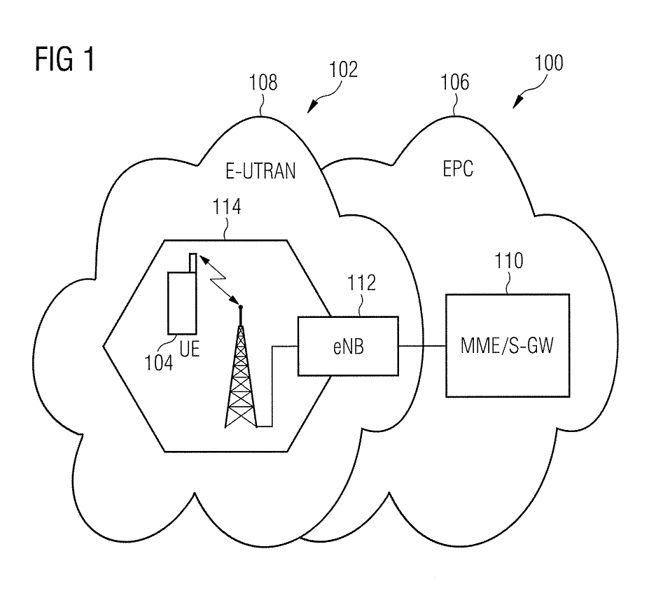

FIG. 1 shows a mobile radio communication system 100 in accordance with an embodiment. The mobile radio communication system 100 may be configured in accordance with the Long Term Evolution mobile radio communication technology. It should be mentioned that any other suitable radio communication technology (e.g. mobile radio communication technology) may be provided in an alternative embodiment. By way of example, any kind of technology that is based on frequency division multiplexing may be provided in an alternative ambodiment of the mobile radio communication system 100 such as e.g. UMTS, WiMAX, WLAN or GSM.

A mobile radio communication system 100 may include a mobile radio communication network 102 and a plurality of mobile radio communication terminal devices 104 (which will also be referred to as User Equipment (UE)). Although only one mobile radio communication terminal device 104 is shown in FIG. 1 for reasons of simplicity, an arbitrary number of mobile radio communication terminal devices 104 may be provided. The mobile radio communication network 102 according to LTE includes a Core Network (also referred to as Evolved Packet Core, EPC) 106 and the mobile radio access communication network (also referred to as Evolved UMTS Terrestrial Radio Access Network, E-UTRAN) 108. In an embodiment, the Core Network 106 may include, inter alia, a Mobility Management Entity (MME) and a Serving Gateway (S-GW) 110 and the mobile radio access communication network 108 may include a plurality of mobile radio base stations (also referred to as evolved NodeB, eNB) 112, wherein one or a plurality of mobile radio base stations may be provided in each mobile radio cell 114 of the mobile radio communication system 100. It should be mentioned that an arbitrary number of mobile radio cells 114 and mobile radio base stations 112 may be provided in an embodiment. In an embodiment, the Mobility Management Entity is provided for the control of the mobility of the mobile radio communication terminal device 104 within the coverage area of a respective mobile radio access communication network 108. Furthermore, in an embodiment, the Serving Gateway includes and thus implements the functions for the transmission of use data between the mobile radio communication terminal device 104 and the mobile radio communication network 102.

In an embodiment, the mobile radio communication system 100 is configured such that in the downlink transmission direction (i.e. in the transmission direction from the mobile radio communication network 102, e.g. from the mobile radio base station 112, to the mobile radio communication terminal device 104), a combined Orthogonal Frequency Division Multiple Access/Time Division Multiple Access (OFDMA/TDMA) transmission method is provided and that in the uplink transmission direction (i.e. in the transmission direction from the mobile radio communication terminal device 104 to the mobile radio communication network 102, e.g. to the mobile radio base station 112), a combined Single Carrier Frequency Division Multiple Access/Time Division Multiple Access (SC-FDMA/TDMA) transmission method is provided. OFDMA/TDMA is a multiple carrier—multiple access method, in which a defined number of subcarriers in the frequency spectrum and a defined transmission time are made available to a user for data transmission. Furthermore, the mobile radio communication system 100 in accordance with LTE is configured for scalable bandwidths, in other words, the mobile radio cells 114 may be operated with e.g. the following bandwidths: 1.4 MHz, 1.6 MHz, 3 MHz, 3.2 MHz, 5 MHz, 10 MHz, 15 MHz, 20 MHz.

In a mobile radio communication system 100 in accordance with LTE, similar to UMTS based on CDMA, a two-stage paging mechanism may be provided. The mobile radio communication terminal device 104 may monitor in regular time distances the paging identifier, which is transmitted via the Physical Downlink Control CHannel (PDCCH) and which paging identifier is assigned to the mobile radio communication terminal device 104 by the network. In case the assigned paging identifier is detected on the PDCCH, then the mobile radio communication terminal device 104 should detect a Physical Downlink Shared CHannel (PDSCH) which is associated with the PDCCH in a defined time distance, via which the paging message is transmitted. For this type of PDSCH, a bandwidth of e.g. 10 MHz (which corresponds to 600 subcarriers) around the carrier frequency is provided. Furthermore, the bandwidth for the PDCCH of the type “paging” (i.e. the bandwidth that is used for transmitting the paging identifiers) may be the same as the bandwidth of the PDSCH of the type “paging”.

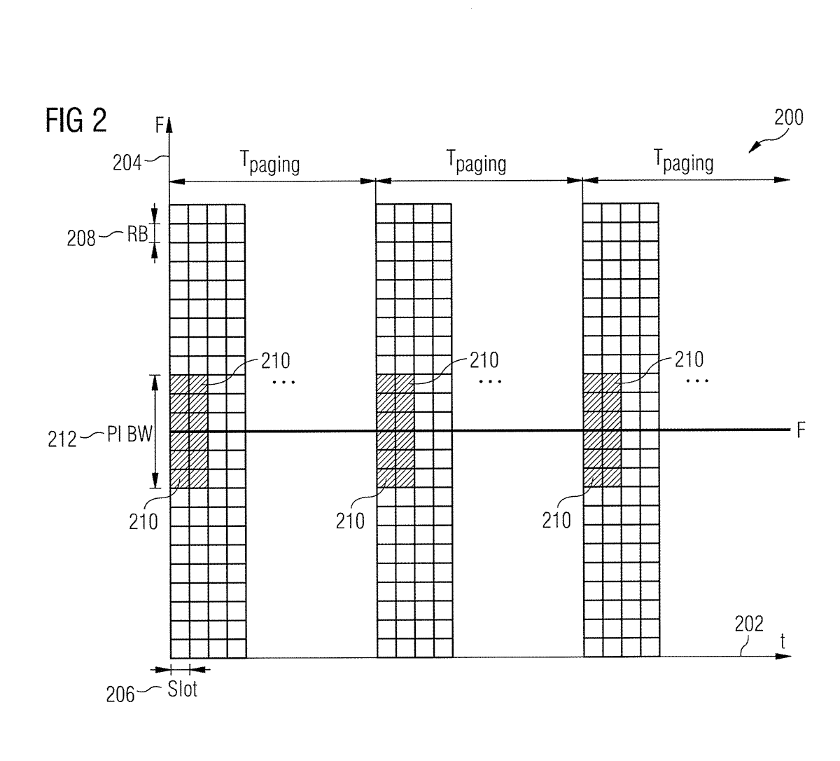

FIG. 2 shows a paging indication scheme in a paging time diagram 200, in accordance with which the PDCCH of the type “paging” is transmitted with a bandwidth of 1.08 MHz (which corresponds to 72 subcarriers or e.g. six resource blocks (RB), each RB for example consisting of 12 subcarriers) around a carrier frequency F0. The paging time diagram 200 shows a time axis (t) 202 and a frequency axis (F) 204. A plurality of time slots 206 of a predefined time duration are shown along the time axis (t) 202. Furthermore, a plurality of resource blocks (RB) 208 of a predefined bandwidth are shown along the frequency axis (F) 204. Within this partitioned time/frequency array, a plurality of resource block/time slot portions 210 (in FIG. 2 shown within a paging identifier bandwidth 212) are provided for the transmission of paging identifiers. In this context it should be mentioned that in an embodiment, the mobile radio communication terminal device 104 decodes the Physical Control Format Indicator CHannel (PCFICH) before decoding a PDCCH. The PCFICH may transmit the information, via how may OFDMA symbols the PDCCH is transmitted per 1 ms.

In an embodiment, in accordance with the Open System Interconnection (OSI) communication protocol reference model of the International Organization for Standardization (ISO), the following channels may be provided in the mobile radio communication system 100 in accordance with LTE:

Physical Channel: PDSCH, PDCCH and PCFICH;

Transport Channel: Paging CHannel (PCH);

Logical Channel: Paging Control CHannel (PCCH).

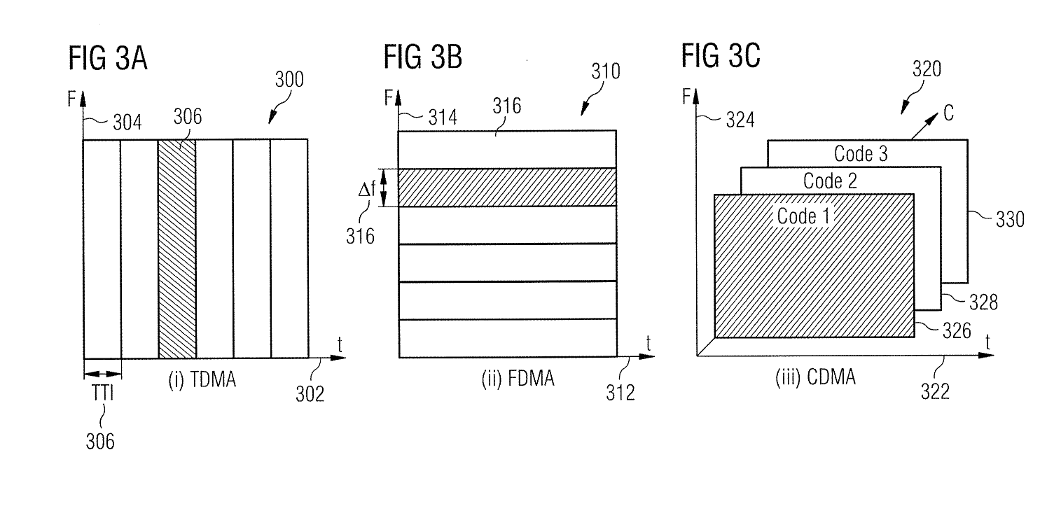

For illustrative reasons, FIGS. 3A to 3C show various diagrams illustrating various multiple access methods, namely time division multiple access (TDMA) (FIG. 3A), frequency division multiple access (FDMA) (FIG. 3B), and code division multiple access (CDMA) (FIG. 3C).

Referring now to FIG. 3A, a TDMA time/frequency diagram 300 includes a time axis (t) 302 and a frequency axis (F) 304. In accordance with a time division multiple access (TDMA) method, the entire frequency band but only a defined transmission time (also referred to as a Transmission Time Interval (TTI)) 306 is available for each user or subscriber for transmitting. During one TTI 306, usually only one transmitter is active.

Referring now to FIG. 3B, an FDMA time/frequency diagram 310 includes a time axis (t) 312 and a frequency axis (F) 314. In accordance with a frequency division multiple access (FDMA) method, the entire time but only a defined (narrow) frequency bandwidth Δf 316 of the entire bandwidth is available for each user or subscriber for transmitting. In each of these frequency bands Δf 316, usually only one transmitter is active.

Referring now to FIG. 3C, a CDMA time/frequency diagram 320 includes a time axis (t) 322 and a frequency axis (F) 324. In accordance with a code division multiple access (CDMA) method, the entire time and the entire frequency bandwidth is available for each user or subscriber for transmitting. In order to avoid a mutual interference of the signals of the different transmitters, each transmitter is assigned with a binary code pattern 326, 328, 330, which are statistically independent from each other. The use signal that is to be transmitted is encoded and spread in a user specific or subscriber specific maner.

Orthogonal Frequency Division Multiple Access (OFDMA) is a particular implementation of FDMA and is a multi-carrier method, in which the signal bandwidth B is divided into a plurality of M orthogonal subbands. Thus, not only one frequency carrier with a large bandwidth is provided, but a plurality of M frequency carriers having the bandwidth Δf=B/M. In accordance with OFDMA, the data stream to be transmitted is divided to a plurality of subbands or subcarriers, and is transmitted in parallel with a correspondingly reduced data rate. In accordance with OFDMA, the entire time and a defined number of subcarriers may be provided for a user or subscriber for transmitting.

In accordance with an OFDM transmission structure, the data to be transmitted are supplied to an OFDM modulator in the sender (e.g. the mobile radio base station eNB 112) in the LTE downlink transmission direction. The OFDM modulator distributes the data symbols in accordance with the OFDM principle to the frequency resources (i.e. the subcarriers). At the output of the OFDM modulator, the data symbols distributed in the frequency domain are transformed into a time domain OFDM symbol, which is eventually transmitted via a transmitting antenna of the sender (e.g. the mobile radio base station eNB 112).

In a receiver (e.g. in the mobile radio communication terminal device 104) the OFDM symbol received by a receiver antenna, is supplied to an OFDM demodulator. The OFDM symbol is transformed back again into the frequency domain in order to thus detect the data symbols distributed per subcarrier.

In an embodiment, the OFDM modulator and the OFDM demodulator may be implemented using an Inverse Fast Fourier Transformation (IFFT) (for the OFDM modulator) and a Fast Fourier Transformation (FFT) (for the OFDM demodulator), respectively. This structure will be described in more detail below.

Various embodiments achieve a saving of energy in a radio communication device when receiving paging signals, e.g. when the radio communication device is in idle or sleep mode and nevertheless configured to receive paging signals. In the following embodiments a “paging channel” may be understood as any physical channel used for carrying paging identifiers. Further, the paging identifier to be transmitted over the mobile radio channel may be understood as paging signal.

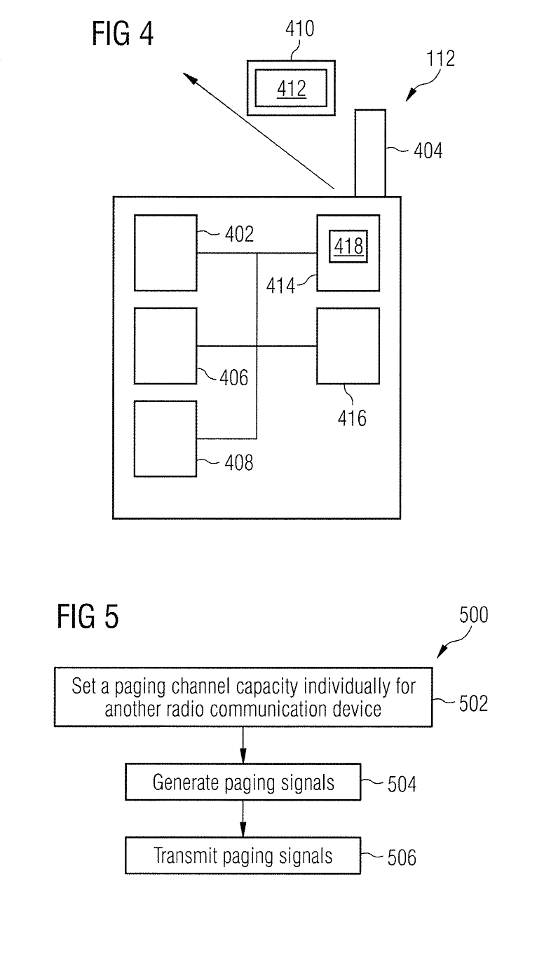

FIG. 4 shows a mobile radio communication network device 112 in accordance with an embodiment. The mobile radio communication network device 112 may include a paging channel capacity setting circuit 402 configured to set a paging channel capacity individually for another radio communication device, e.g. for the mobile radio communication terminal devices 104 which are present in the coverage area of the mobile radio communication network device 112.

In an example, the mobile radio communication network device 112 is configured in accordance with Long Term Evolution communication technology. In an implementation, the mobile radio communication network device 112 may further include one or more transmitter antennas 404 and/or one or more receiver antennas 404. Furthermore, optionally, the mobile radio communication network device 112 may further include a paging signal generating circuit 406 configured to generate paging signals. Further, in an example of this embodiment, a paging channel capacity message generating circuit 408 configured to generate a paging channel capacity message 410 to be transmitted to another radio communication device may be provided, wherein the paging channel capacity message 410 may include paging channel capacity information 412 to define the paging channel capacity for the other radio communication device. In other words, the paging channel capacity information 412 may provide information for the other radio communication device as to which frequency bands it should scan for paging signals. In an embodiment, the paging channel capacity message may include a timer information depending on which the paging channel capacity should be set (the timer information may be implemented by a counter information, for example).

The mobile radio communication network device 112 may optionally further include a transmitter 414 coupled to the antenna(s) 404. The transmitter 414 may be configured to transmit paging signals.

Furthermore, in an implementation, a transmitter setting circuit 416 may be provided configured to set the transmitter 414 in accordance with the paging signals to be transmitted. In an example, the respective frequencies used for the transmission of the paging signals are set in the transmitter 414 by the transmitter setting circuit 416.

As will be described in more detail below, the transmitter 414 may include a modulator 418. The modulator 418 may be a frequency division multiplex modulator. In an alternative implementation, the modulator 418 may be a time division multiplex modulator. In yet another implementation modulator 418 may be an orthogonal frequency division multiplex modulator.

As will be described in more detail below, the paging channel capacity setting circuit 402 may be configured to set the paging channel capacity in accordance with a channel capacity setting schedule.

By way of example of this embodiment, the paging channel capacity setting circuit 402 may be configured to set the frequency bandwidth of the paging channel.

Furthermore, in an exemplary implementation of this embodiment, the paging channel capacity setting circuit 402 may be configured to set the frequency bandwidth of the paging channel in accordance with a channel bandwidth setting schedule. In an example, the paging channel capacity setting circuit 402 may be configured to set the frequency bandwidth of the paging channel in dependence of a time period during which the radio communication device has not being paged.

In yet another implementation of this embodiment, the paging channel capacity setting circuit 402 may be configured to change the paging channel to a new paging channel if a predefined criterion is fulfilled. In this example, a frequency hopping method may be used, which changes the used paging channels in accordance with a predefined frequency hopping scheme. The predefined criterion may be a predefined paging channel bandwidth, e.g. a predefined minimum paging channel bandwidth. The new paging channel may be arranged within a predefined frequency range, e.g. within the initial paging channel (in other words, the new paging channel may be located in a frequency band that has been used for paging when the other mobile radio communication device (e.g. the mobile radio communication terminal device 104) first registers with the mobile radio communication device 112, e.g. the mobile radio base station 112, or enters into its idle or sleep mode). In idle or sleep mode, there is no active connection for data transmission between the user mobile radio communication terminal device and the mobile radio communication network. However, the user mobile radio communication terminal device is configured to receive paging signals, e.g. to receive a notification about an incoming call.

Moreover, in an example, the paging channel capacity setting circuit 402 may be configured to reduce, e.g. in accordance with a predefined frequency bandwidth reduction scheme, e.g. step-wise, the frequency bandwidth of the paging channel in dependence of a time period during which the radio communication device has not being paged.

FIG. 5 shows a method 500 for controlling a mobile radio communication network device 112 in accordance with an embodiment.

As shown in FIG. 5, in 502, a paging channel capacity is set individually for another radio communication device, e.g. for one or for a plurality of radio communication terminal devices such as e.g. the mobile radio communication device 104.

Then, optionally, in 504, the paging signals are generated. Generating the paging signals may include generating a paging channel capacity message 410 to be transmitted to another radio communication device, wherein the paging channel capacity message 410 may include paging channel capacity information to define the paging channel capacity for the other radio communication device. Furthermore, the paging channel capacity message 410 may include a timer information 412 depending on which the paging channel capacity will and should be set.

Then, again optionally, in 506, the paging signals (which may be included in the paging channel capacity message 410), may be transmitted.

The method 500 may further include setting a transmitter (and/or a transmitter antenna) of the radio communication device in accordance with the paging signals to be transmitted.

The transmitting of the paging signals may include a modulating of the paging signals. The modulating may in an example include a frequency division multiplex modulating. Further, the modulating may in an example include a time division multiplex modulating. In yet another example, the modulating may include an orthogonal frequency division multiplex modulating.

The paging channel capacity may be set in accordance with a channel capacity setting schedule.

Furthermore, the method may include a setting of a frequency bandwidth of the paging channel. The frequency bandwidth of the paging channel may be set in accordance with a channel bandwidth setting schedule. Furthermore, the frequency bandwidth of the paging channel may be set in dependence of a time period during which the radio communication device has not being paged.

In another example of this method, the paging channel may be changed to a new paging channel if a predefined criterion is fulfilled. The predefined criterion may be a predefined paging channel bandwidth, wherein the new paging channel may be arranged within a predefined frequency range. In another example of this embodiment, the new paging channel may be arranged within the initial paging channel.

Furthermore, the frequency bandwidth of the paging channel may be reduced in dependence of a time period during which the radio communication device has not being paged.

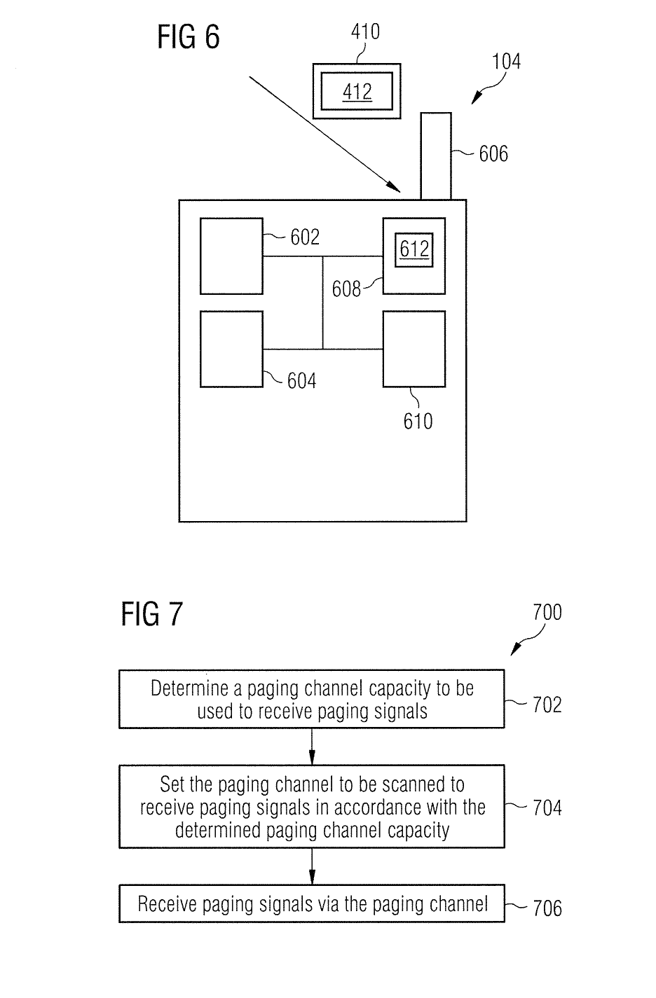

FIG. 6 shows a mobile radio communication terminal device 104 in accordance with an embodiment.

The mobile radio communication terminal device 104 may include a paging channel capacity determining circuit 602 configured to determine a paging channel capacity to be used to receive paging signals, and a paging channel capacity setting circuit 604 configured to set the paging channel to be scanned to receive paging signals in accordance with the determined paging channel capacity.

In an example, the mobile radio communication terminal device 104 is configured in accordance with Long Term Evolution communication technology. In an implementation, the mobile radio communication terminal device 104 may further include one or more transmitter antennas 606 and/or one or more receiver antennas 606.

In an example, the paging channel capacity determining circuit 602 may be configured to determine the paging channel capacity in accordance to a paging channel capacity message 410 transmitted from another radio communication device, e.g. the mobile radio base station 112. The paging channel capacity message 410 may include a timer information 412 (which may be implemented as a counter information) depending on which the paging channel capacity will and should be set.

In an example, the mobile radio communication terminal device 104 may further include a receiver 608 configured to receive paging signals and optionally to receive use data that is transmitted during a data transmission connection that is established in response to the receipt of corresponding paging signals.

In an example, the mobile radio communication terminal device 104 may further include a receiver setting circuit 610 configured to set the receiver in accordance with the received paging signals.

The receiver 608 may include a demodulator 612. The demodulator 612 may be a frequency division multiplex demodulator. In another example, the demodulator 612 may be a time division multiplex demodulator. In yet another example, the demodulator 612 may be an orthogonal frequency division multiplex demodulator.

In another implementation of this embodiment, the paging channel capacity setting circuit 604 may be configured to set the paging channel to be scanned to receive paging signals in accordance with a channel capacity setting schedule.

In another example, the paging channel capacity setting circuit 604 may be configured to set the frequency bandwidth of the paging channel. By way of example, the paging channel capacity setting circuit 604 may be configured to set the frequency bandwidth of the paging channel in accordance with a channel bandwidth setting schedule.

Furthermore, the paging channel capacity setting circuit 604 may be configured to set the frequency bandwidth of the paging channel in dependence of a time period during which the radio communication device has not being paged.

In yet another example of this embodiment, the paging channel capacity setting circuit 604 may be configured to change the used paging channel to a new paging channel if a predefined criterion is fulfilled. The predefined criterion may be a predefined paging channel bandwidth. The new paging channel may be arranged within a predefined frequency range. Moreover, the new paging channel may be arranged within the initial paging channel.

In another implementation of this embodiment, the paging channel capacity setting circuit 604 may be configured to reduce the frequency bandwidth of the paging channel in dependence of a time period during which the radio communication device has not being paged.

The radio communication device may be a radio communication terminal device, e.g. a mobile radio communication terminal device, e.g. a mobile radio communication terminal device in accordance with Long Term Evolution communication technology.

FIG. 7 shows a method 700 for controlling a mobile radio communication terminal device in accordance with an embodiment.

As shown in FIG. 7, in 702, a paging channel capacity to be used to receive paging signals is determined. In 704, the paging channel to be scanned to receive paging signals is set in accordance with the determined paging channel capacity. The paging channel capacity may be determined in accordance with a paging channel capacity message 410 transmitted from another radio communication device, e.g. the corresponding mobile radio base station 112 which is responsible for the mobile radio cell 114, in which the mobile radio communication terminal device is currently registered. The paging channel capacity message 410 may include a timer information depending on which the paging channel capacity should be set. Furthermore, the paging channel capacity may be set in accordance with the received timer information.

In an example of this embodiment, optionally, in 706, paging signals are received via the paging channel.

The method may optionally further include setting a receiver of the communication device in accordance with the received paging signals.

The method may optionally further include demodulating received paging signals. The demodulating may be carried out in accordance with a frequency division multiplex method. Alternatively, the demodulating may be carried out in accordance with a time division multiplex method. In yet another example, the demodulating may be carried out in accordance with an orthogonal frequency division multiplex method.

The paging channel to be scanned may be set to receive paging signals in accordance with a channel capacity setting schedule. Furthermore, the frequency bandwidth of the paging channel may be set. Further, the frequency bandwidth of the paging channel may be set in accordance with a channel bandwidth setting schedule. Moreover, the frequency bandwidth of the paging channel may be set in dependence of a time period during which the radio communication device has not being paged.

In another example of this embodiment, the used paging channel may be changed to a new paging channel if a predefined criterion is fulfilled. The predefined criterion may be a predefined paging channel bandwidth. In an example, the new paging channel may be arranged within a predefined frequency range. The new paging channel may be arranged within the initial paging channel. The frequency bandwidth of the paging channel may be reduced in dependence of a time period during which the radio communication device has not being paged.

In another embodiment, a radio communication device (e.g. a mobile radio communication network device) is provided. The radio communication device may include a paging channel capacity setting circuit configured to set a plurality of different paging channel capacities for a plurality of radio communication devices. It should be mentioned that the above examples of the above embodiment which may refer to a mobile radio communication network device, may also be used within this embodiment.

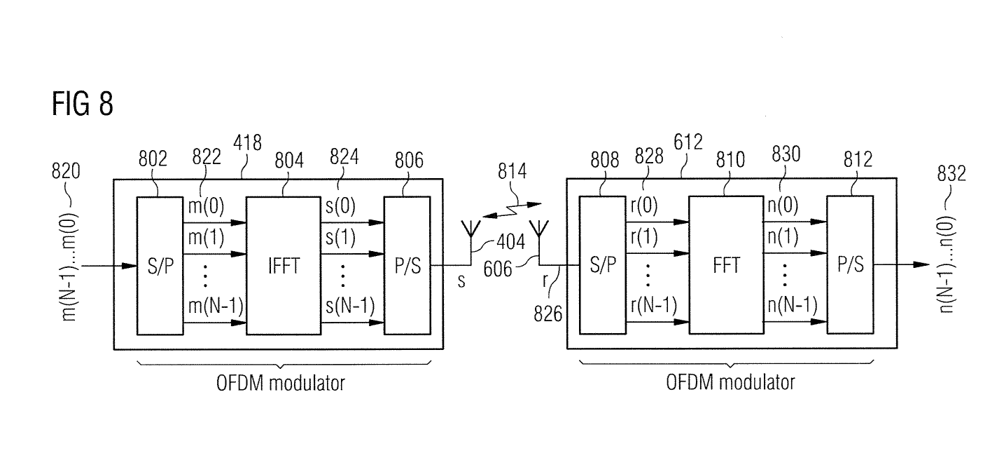

FIG. 8 shows an implementation of an orthogonal frequency division multiplex modulator 418 (e.g. provided in the transmitter 414 of the mobile radio communication network device 112) and of an orthogonal frequency division multiplex demodulator 612 (e.g. provided in the receiver 608 of the mobile radio communication terminal device 104) using inverse fast fourier transformation and fast fourier transformation, respectively.

In an example, the orthogonal frequency division multiplex modulator 418 may include (coupled in downstream serial connection) a modulator serial/parallel converter 802, an inverse fast fourier transformation (IFFT) circuit 804, and a modulator parallel/serial converter 806. Inputs of the inverse fast fourier transformation (IFFT) circuit 804 are coupled with outputs of the modulator serial/parallel converter 802. Furthermore, inputs of the modulator parallel/serial converter 806 are coupled with outputs of the inverse fast fourier transformation (IFFT) circuit 804. An output of the modulator parallel/serial converter 806 is coupled with the transmitting antenna 404 for transmitting radio signals via a mobile radio channel 814 e.g. from the mobile radio communication network device 112 to e.g. the mobile radio communication terminal device 104.

As shown in FIG. 8, a serial data stream 820 to be transmitted m(i) (i=0, . . . , N-1, wherein N is an arbitrary integer value) may be supplied to the modulator serial/parallel converter 802, where the serial data stream 820 is converted into a parallel data stream 822 provided at the outputs of the modulator serial/parallel converter 802. The parallel data stream 822 is supplied to the inputs of the inverse fast fourier transformation (IFFT) circuit 804. Each data symbol provided at one of the inputs of the inverse fast fourier transformation (IFFT) circuit 804 corresponds to the distribution of a data symbol on a subcarrier. The inverse fast fourier transformation (IFFT) circuit 804 transforms the data symbols into the time domain, in other words, the inverse fast fourier transformation (IFFT) circuit 804 generates N time discrete samples of an OFDM symbol and provides the time discrete samples of an OFDM symbol at its outputs. The time discrete samples of an OFDM symbol are supplied to the inputs of the modulator parallel/serial converter 806. The modulator parallel/serial converter 806 assembles the received samples to an OFDM symbol s(i) 824 (i=0, . . . , N-1, wherein N is an arbitrary integer value).

In an example, the orthogonal frequency division multiplex demodulator 612 may include (coupled in downstream serial connection) a demodulator serial/parallel converter 808, a fast fourier transformation (FFT) circuit 810, and a demodulator parallel/serial converter 812. Inputs of the fast fourier transformation (FFT) circuit 810 are coupled with outputs of the demodulator serial/parallel converter 808. Furthermore, inputs of the demodulator parallel/serial converter 812 are coupled with outputs of the fast fourier transformation (FFT) circuit 810. An input of the demodulator serial/parallel converter 808 is coupled with the receiving antenna 606 for receiving radio signals which are transmitted via the mobile radio channel 814 e.g. from the mobile radio communication network device 112 to e.g. the mobile radio communication terminal device 104.

As shown in FIG. 8, a received OFDM symbol r(i) 826 (i=0, . . . , N-1, wherein N is an arbitrary integer value) is supplied to the demodulator serial/parallel converter 808, where the serial OFDM symbol r(i) 826 is converted into a parallel data stream 828 provided at the outputs of the demodulator serial/parallel converter 808. The parallel data stream 828 is supplied to the inputs of the fast fourier transformation (FFT) circuit 810. Each data symbol (or the time discrete samples of the OFDM symbol) provided at one of the inputs of the fast fourier transformation (FFT) circuit 810 is transformed back into the frequency domain, in order to thus determine the N data symbols n(i) (i=0, . . . , N-1, wherein N is an arbitrary integer value) 830 that are distributed per subcarrier. The N data symbols n(i) 830 are provided in parallel at the outputs of the fast fourier transformation (FFT) circuit 810 and are supplied to the inputs of the demodulator parallel/serial converter 812, which provides a serial stream 832 of the N data symbols n(i) for further processing in the receiver and/or further components of e.g. the mobile radio communication terminal device 104.

The FFT and IFFT provide efficient algorithms for a transformation of signals from the time domain into the frequency domain (in case of the FFT) and from the frequency domain into the time domain (in case of the IFFT). In this case, N input values are transformed into N output values. For a very efficient use of the FFT/IFFT, the number N should be a number to the power of two. However, it should be noted that the complexity of FFT/IFFT implementation increases the higher the number of input values N is.

As described above and as will be described in more detail below, in various embodiments, a transmission of paging identifiers is provided (e.g. in an LTE mobile radio communication system) which is efficient for the respective mobile radio communication terminal device.

In various embodiments, the bandwidth for the transmission of the paging identifiers is configurable or settable and it can be configured or set differently from mobile radio cell to mobile radio cell. Furthermore, the paging identifier bandwidth may be determined and configured or set on the basis of the carrier frequency of the respective mobile radio cell.

In the configuration or setting of the transmission time instants for transmitting the paging identifiers, in an example, an additional timer information (e.g. implemented in form of a counter) may be signalled (e.g. from the mobile radio base station 112 to the mobile radio communication terminal device 104). The additional timer information may be used for adapting (e.g. reducing) the paging identifier bandwidth (e.g. step-wise) by a predefined factor (which may be signalled using the additional timer information). In an example, it may be provided that the more rarely a respective mobile radio communication terminal device 104 is paged, the more the paging identifier bandwidth monitored by the respective mobile radio communication terminal device 104 will be reduced.

Furthermore, in an embodiment, a radio communication device may be provided having a paging channel capacity setting circuit configured to change the used paging channel to a new paging channel if a predefined criterion is fulfilled. The radio communication device may be a radio communication network device (such as e.g. the mobile radio base station 112) or a radio communication terminal device (such as e.g. the mobile radio communication terminal device 104). This embodiment may be combined with the above described embodiments, if desired.

The predefined criterion may be a predefined paging channel bandwidth. Furthermore, the new paging channel may be arranged within a predefined frequency range, as will be described in more detail below.

Illustratively, in this embodiment, the radio communication network device (such as e.g. the mobile radio base station 112) may be configured to use a frequency hopping method for the transmission of the paging identifiers, e.g. in order to achieve a frequency diversity gain.

In various implementations of the frequency hopping method used in the mobile radio cell 114, different options may be provided.

In a first option, the frequency hopping method may be carried out within the entire bandwidth of the mobile radio cell 114. Alternatively, the frequency hopping method may be limited to a predefined bandwidth, by way of example, it may be limited to the initial paging identifier bandwidth, in other words, to the frequency range and the bandwidth that has been used at the beginning of the transmission of the paging identifiers in the case of the provision of a reduction of the paging identifier bandwidth individually for a radio communication device.

In a second option, the frequency hopping method may be carried out in accordance with a predefined channel bandwidth setting schedule (also referred to as a predefined channel bandwidth setting pattern). By way of example, one or more of the following examples may be provided:

a) A predefined channel bandwidth setting schedule may be used which is fixedly predefined in the mobile radio communication network device 112. This provides a very simple and efficient frequency hopping method.

b) A predefined channel bandwidth setting schedule may be used which is in a fixed association with the transmission of reference signals within the mobile radio cell 114.

c) A plurality of fixedly defined orthogonal patterns are configured in the mobile radio cell 114 und the used pattern is signalled from the mobile radio communication network device 112 to the mobile radio communication terminal device 104. This alternative allows a high degree of flexibility in the case of a high number of mobile radio communication terminal devices 104 to be paged in the mobile radio cell 114.

Various embodiments provide a gain regarding the achievable battery (or accumulator) run-time of a mobile radio communication terminal device, e.g. since the receiver of the mobile radio communication terminal device is operated in a narrow frequency band (e.g. when it is in idle or sleep mode) for a longer period of time, e.g. when monitoring for paging signals. Furthermore, the signal processing complexity in the receiver of the mobile radio communication terminal device may be reduced.

Without limiting the general applicability of the described embodiments, in an example, the following configuration will be assumed:

The mobile radio communication system 100 may be configured in accordance with the Long Term Evolution mobile radio communication technology using the OFDMA/TDMA multiple access method in the downlink transmission direction.

The radio transmission technology Frequency Division Duplex (FDD) is used, in other words, the transmission of data in the downlink transmission direction and in the uplink transmission direction is provided using separate frequency bands.

A Long Term Evolution mobile radio cell is assumed having a frequency bandwidth of 20 MHz, in which in the downlink transmission direction and in the uplink transmission direction maximum 100 resource blocks (RB) in each direction are available for data transmission.

The physical channels PCFICH and PDCCH of the type “paging” are transmitted using the same bandwidth.

In an implementation of this example, the transmission of the paging identifiers may be configured as follows:

Paging identifiers are transmitted on the PDCCH initially using a first paging identifier bandwidth PI BW1 of e.g. 24 RBs into the mobile radio cell.

The transmission of the paging identifiers on the PDCCH is carried out after the expiration of a respective paging time T_{paging}, in other words, every T_{paging} of e.g. 320 ms.

A paging cycle time T_{paging}_{_{—}}_{cycle} is configured (e.g. having a value T_{paging}_{_{—cycle}} of 2.56 s). Using the paging cycle time T_{paging}_{_{—}}_{cycle}, the used paging identifier bandwidth is reduced in a step-wise manner by a factor 2 in case the respective mobile radio communication terminal device has not been paged within this time interval defined by the paging cycle time T_{paging}_{_{—}}_{cycle}.

The minimum bandwidth for the transmission of the paging identifiers is six resource blocks (RBs).

In this example, no frequency hopping method is applied for the PDCCH of the type “paging”.

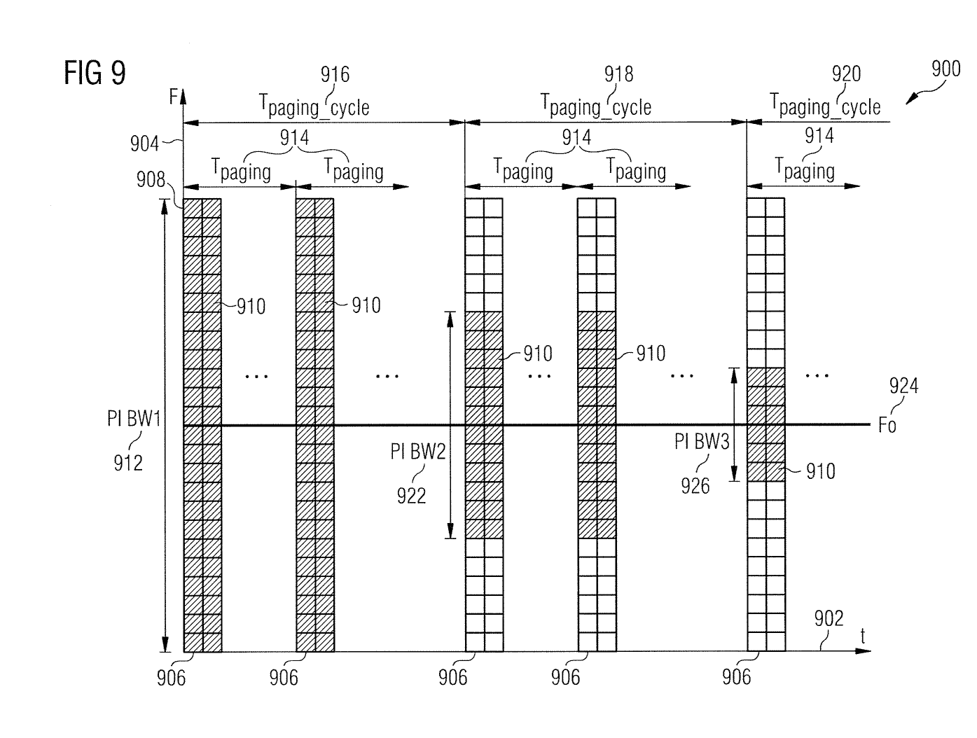

FIG. 9 shows a paging indication scheme in a paging time diagram 900 in accordance with an example.

In this example, the paging channel, i.e. PDCCH of the type “paging” is transmitted initially with a bandwidth of 1.08 MHz (which corresponds to 72 subcarriers or e.g. six resource blocks (RB), each RB for example consisting of 12 subcarriers) around a carrier frequency F0 924. The paging channel carries a defined number of paging identifiers (bit patterns). The paging time diagram 900 shows a time axis (t) 902 and a frequency axis (F) 904. A plurality of time slots 906 of a predefined time duration are shown along the time axis (t) 902. Furthermore, a plurality of resource blocks (RB) 908 of a predefined bandwidth are shown along the frequency axis (F) 904. Within this partitioned time/frequency array, a plurality of resource block/time slot portions 910 (in FIG. 9 shown within a first paging identifier bandwidth PI BW1 912) are provided for the transmission of paging identifiers. In this context it should be mentioned that in an embodiment, the mobile radio communication terminal device 104 decodes the Physical Control Format Indicator CHannel (PCFICH) before decoding a PDCCH. The PCFICH may transmit the information, via how may OFDMA symbols the PDCCH is transmitted per 1 ms. In this example, the transmission of paging signals is started repeatedly after the expiration of a paging time T_{paging} 914. The paging time T_{paging} 914 is assumed to be 320 ms, but any other suitable paging time T_{paging} 914 may be provided in an alternative example. Furthermore, FIG. 9 shows a paging cycle time T_{paging}_{_{—}}_{cycle} 916, 918, 920, which is used to determine the time instants for a respective reduction of the paging identifier bandwidth used for a respective mobile radio communication terminal device 104 if it has not been paged during this time period defined by the paging cycle time T_{paging}_{_{—}}_{cycle} 916, 918, 920. The paging cycle time T_{paging}_{_{—}}_{cycle} 916, 918, 920, is assumed to be 2.56 s, but any other suitable paging cycle time T_{paging}_{_{—}}_{cycle} 916, 918, 920, may be provided in an alternative example. The paging cycle time T_{paging}_{_{—}}_{cycle} 916, 918, 920, may be longer than the respectively provided paging time T_{paging} 914, e.g. longer by a predefined factor (e.g. longer by a predefined integer factor, e.g. longer by a factor 8).

The paging time diagram 900 illustrates the course of the transmission of the paging signals.

For reasons of simplicity, FIG. 9 only shows 24 of the entirely provided 100 resource blocks of the mobile radio cell 114.

In this example, it is assumed that the mobile radio communication terminal device 104 is not paged within the first time interval of 2*2.56 s, namely during the first two paging cycle times T_{paging}_{_{—}}_{cycle} 916, 918. Thus, after the expiration of the first paging cycle time T_{paging}_{_{—}}_{cycle} 916, in this example, the first paging identifier bandwidth PI BW1 912 is reduced to a second paging identifier bandwidth PI BW2 922, e.g. around the carrier frequency F0 924 of the mobile radio cell 114. The reduction may be by a predetermined factor, e.g. by a factor 2. Thus, in an example, the second paging identifier bandwidth PI BW2 922 has half the bandwidth than the first paging identifier bandwidth PI BW1 912.

Then, after the expiration of the second paging cycle time T_{paging}_{_{—}}_{cycle} 918, in this example, the second paging identifier bandwidth PI BW2 912 is reduced to a third paging identifier bandwidth PI BW3 926, e.g. again around the carrier frequency F0 924 of the mobile radio cell 114. The reduction may again be by a predetermined factor, e.g. again by a factor 2, although another factor may be provided in an alternative example. Thus, in an example, the third paging identifier bandwidth PI BW3 926 has half the bandwidth than the second paging identifier bandwidth PI BW2 922.

Thus, as illustrated in FIG. 9, the mobile radio communication terminal device 104 then, during the third paging cycle time T_{paging}_{_{—}}_{cycle} 920, focuses only to a reduced number of subcarriers for monitoring and receiving paging signals, in other words for detecting the paging identifiers, e.g. only to the 72 subcarriers around the carrier frequency F0 924 of the mobile radio cell 114.

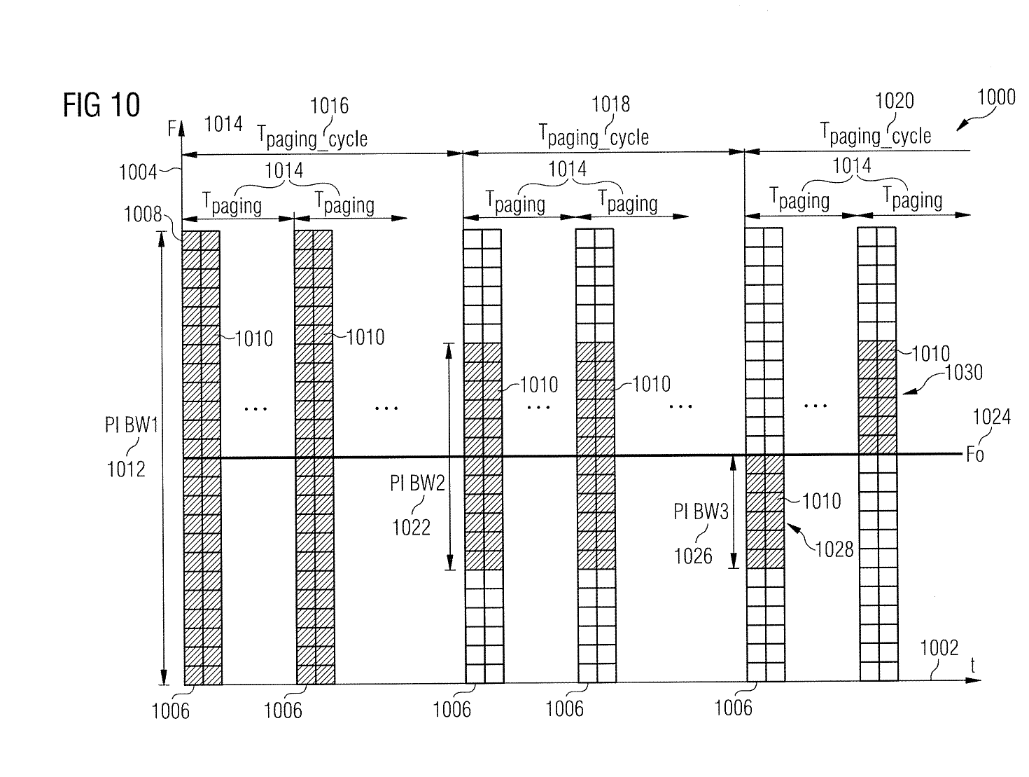

FIG. 10 shows a paging indication scheme in a paging time diagram 1000 in accordance with another example using a frequency hopping method.

In this example, the paging channel, i.e. PDCCH of the type “paging” is transmitted initially with a bandwidth of 1.08 MHz (which corresponds to 72 subcarriers or e.g. six resource blocks (RB), each RB for example consisting of 12 subcarriers) around a carrier frequency F0 1024. The paging channel carries a defined number of paging identifiers (bit patterns). The paging time diagram 1000 shows a time axis (t) 1002 and a frequency axis (F) 1004. A plurality of time slots 1006 of a predefined time duration are shown along the time axis (t) 1002. Furthermore, a plurality of resource blocks (RB) 1008 of a predefined bandwidth are shown along the frequency axis (F) 1004. Within this partitioned time/frequency array, a plurality of resource block/time slot portions 1010 (in FIG. 10 shown within a first paging identifier bandwidth PI BW1 1012) are provided for the transmission of paging identifiers. In this context it should be mentioned that in an embodiment, the mobile radio communication terminal device 104 decodes the Physical Control Format Indicator CHannel (PCFICH) before decoding a PDCCH. The PCFICH may transmit the information, via how may OFDMA symbols the PDCCH is transmitted per 1 ms. In this example, the transmission of paging signals is started repeatedly after the expiration of a paging time T_{paging} 1014. The paging time T_{paging} 1014 is assumed to be 320 ms, but any other suitable paging time T_{paging} 1014 may be provided in an alternative example. Furthermore, FIG. 10 shows a paging cycle time T_{paging}_{_{—}}_{cycle} 1016, 1018, 1020, which is used to determine the time instants for a respective reduction of the paging identifier bandwidth used for a respective mobile radio communication terminal device 104 if it has not been paged during this time period defined by the paging cycle time T_{paging}_{_{—}}_{cycle} 1016, 1018, 1020. The paging cycle time T_{paging}_{_{—}}_{cycle} 1016, 1018, 1020, is assumed to be 2.56 s, but any other suitable paging cycle time T_{paging}_{_{—}}_{cycle} 1016, 1018, 1020, may be provided in an alternative example. The paging cycle time T_{paging}_{_{—}}_{cycle} 1016, 1018, 1020, may be longer than the respectively provided paging time T_{paging} 1014, e.g. longer by a predefined factor (e.g. longer by a predefined integer factor, e.g. longer by a predefined integer factor 8).

The paging time diagram 1000 illustrates the course of the transmission of the paging signals.

For reasons of simplicity, FIG. 10 only shows 24 of the entirely provided 100 resource blocks of the mobile radio cell 114.

In this example, it is assumed that the mobile radio communication terminal device 104 is not paged within the first time interval of 2*2.56 s, namely during the first two paging cycle times T_{paging}_{_{—}}_{cycle} 1016, 1018. Thus, after the expiration of the first paging cycle time T_{paging}_{_{—}}_{cycle} 1016, in this example, the first paging identifier bandwidth PI BW1 1012 is reduced to a second paging identifier bandwidth PI BW2 1022, e.g. around the carrier frequency F0 1024 of the mobile radio cell 114. The reduction may be by a predetermined factor, e.g. by a factor 2. Thus, in an example, the second paging identifier bandwidth PI BW2 1022 has half the bandwidth than the first paging identifier bandwidth PI BW1 1012.

Then, after the expiration of the second paging cycle time T_{paging}_{_{—}}_{cycle} 1018, in this example, the second paging identifier bandwidth PI BW2 1022 is reduced to a third paging identifier bandwidth PI BW3 1026, below the carrier frequency F0 1024 of the mobile radio cell 114 (in other words, the frequency range of the third paging identifier bandwidth PI BW3 1026 is illustratively shifted down by a plurality of (with reference to the carrier frequency F0 1024). The reduction may again be by a predetermined factor, e.g. again by a factor 2, although another factor may be provided in an alternative example. Thus, in an example, the third paging identifier bandwidth PI BW3 1026 has half the bandwidth than the second paging identifier bandwidth PI BW2 1022. Furthermore, in this example, the third paging identifier bandwidth PI BW3 1026 is a minimum paging identifier bandwidth that may be used for transmitting paging identifiers. Furthermore, the third paging identifier bandwidth PI BW3 1026 serves as a frequency hopping starting bandwidth. In other words, a frequency hopping method is started when the predefined minimum paging identifier bandwidth is achieved. This means, that the frequency range is changed but still using the same minimum frequency bandwidth. In this example, in each paging time T_{paging} 1014 the frequency range is shifted within a predefined frequency band, e.g. within the first paging identifier bandwidth PI BW1 1012, from a first frequency range 1028, e.g. below the carrier frequency F0 1024 of the mobile radio cell 114, to a second frequency range 1030, e.g. above the carrier frequency F0 1024 of the mobile radio cell 114.

Thus, the example shown in FIG. 10 differs from the example shown in FIG. 9 e.g. in that a frequency hopping method is applied for the PDCCH of the type “paging” at the smallest bandwidth of six resource blocks (which correspond to 72 subcarriers). In this example, a pattern fixedly defined in the mobile radio cell 114 is used and the frequency hopping method is limited to the initial (first) paging identifier bandwidth PI BW1 1012.

In this example it is assumed that a frequency hopping method is applied with a cyclic shift of e.g. six resource blocks per paging identifier transmission time instant, with an initial shift by minus three resource blocks (with reference to the carrier frequency F0 1024).

While the invention has been particularly shown and described with reference to specific embodiments, it should be understood by those skilled in the art that various changes in form and detail may be therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A radio communication device, comprising:
a paging channel capacity determining circuit configured to determine a paging channel capacity to be used to receive paging signals; and
a paging channel capacity setting circuit configured to set the paging channel to be scanned to receive paging signals in accordance with the determined paging channel capacity.

2. The radio communication device of claim 1,
wherein the paging channel capacity determining circuit is configured to determine the paging channel capacity in accordance with a paging channel capacity message transmitted from another radio communication device.

3. The radio communication device of claim 2,
wherein the paging channel capacity message comprises a timer information depending on which the paging channel capacity should be set.

4. The radio communication device of claim 1, further comprising:
a receiver configured to receive paging signals.

5. The radio communication device of claim 4, further comprising:
a receiver setting circuit configured to set the receiver in accordance with the received paging signals.

6. The radio communication device of claim 1,
being configured as a radio communication terminal device

7. The radio communication device of claim 1,
wherein the paging channel capacity setting circuit is configured to set the frequency bandwidth of the paging channel.

8. The radio communication device of claim 7,
wherein the paging channel capacity setting circuit is configured to set the frequency bandwidth of the paging channel in dependence on a time period during which the radio communication device has not being paged.

9. The radio communication device of claim 1,
wherein the paging channel capacity setting circuit is configured to change the used paging channel to a new paging channel if a predefined criterion is fulfilled.

10. The radio communication device of claim 9,
wherein the predefined criterion is a predefined paging channel bandwidth.

11. The radio communication device of claim 9,
wherein the new paging channel is arranged within a predefined frequency range.

12. A method for controlling a radio communication device, the method comprising:
determining a paging channel capacity to be used to receive paging signals; and
setting the paging channel to be scanned to receive paging signals in accordance with the determined paging channel capacity.

13. The method of claim 12,
wherein the paging channel capacity is determined in accordance with a paging channel capacity message transmitted from another radio communication device.

14. The method of claim 12,
wherein the paging channel capacity is set in accordance with a received timer information.

15. The method of claim 12, further comprising:
step-wise reducing the paging channel capacity to be used to receive paging signals.

16. The method of claim 12,
wherein the frequency bandwidth of the paging channel is set.

17. The method of claim 16,
wherein the frequency bandwidth of the paging channel is set in accordance with a channel bandwidth setting schedule.

18. A radio communication device, comprising:
a paging channel capacity setting circuit configured to set a paging channel capacity individually for another radio communication device.

19. The radio communication device of claim 18,
being configured as a radio communication network device

20. The radio communication device of claim 18, further comprising:
a paging signal generating circuit configured to generate paging signals.

21. The radio communication device of claim 18, further comprising:
a paging channel capacity message generating circuit configured to generate a paging channel capacity message to be transmitted to another radio communication device, wherein the paging channel capacity message comprises paging channel capacity information to define the paging channel capacity for the other radio communication device.

22. The radio communication device of claim 21,
wherein the paging channel capacity message comprises a timer information depending on which the paging channel capacity should be set.

23. The radio communication device of claim 18,
wherein the paging channel capacity setting circuit is configured to set the frequency bandwidth of the paging channel.

24. A method for controlling a radio communication device, the method comprising:
setting a paging channel capacity individually for another radio communication device.

25. A radio communication device, comprising:
a paging channel capacity setting circuit configured to change the used paging channel to a new paging channel if a predefined criterion is fulfilled.
